(19) United States
(12) Patent Application Publication
(10) Pub. No.: US 2013/0305729 A1
(43) Pub. Date: Nov. 21, 2013

(54) TURBOMACHINE COMBUSTOR AND METHOD FOR ADJUSTING COMBUSTION DYNAMICS IN THE SAME

(71) Applicants: Mahesh Bathina, Ongole (IN); Madanmohan Manoharan, Chennai (IN)

(72) Inventors: Mahesh Bathina, Ongole (IN); Madanmohan Manoharan, Chennai (IN)

(73) Assignee: GENERAL ELECTRIC COMPANY, Schenectady, NY (US)

(21) Appl. No.: 13/476,413

(22) Filed: May 21, 2012

(51) Int. Cl. F02C 7/24; F02C 3/04

(52) U.S. Cl. 60/772; 60/725; 60/805

(57) ABSTRACT

A turbomachine combustor includes a combustor cap having a cap surface and a wall that define, at least in part, a resonator volume. A plurality of injection nozzle members extend from the cap surface. Each of the plurality of injection nozzle members include an inner nozzle member and a plurality of outer nozzle members. An adjustable conduit extends through the wall into the resonator volume. The adjustable conduit includes an internal passage having a dimensional parameter. A combustor dynamics mitigation system is operably connected to the combustor cap. The combustor dynamics mitigation system includes a controller configured and disposed to control one a size of the resonator volume and the dimensional parameter of the adjustable conduit to modify combustor dynamics in the combustor.

### BACKGROUND OF THE INVENTION

The subject matter disclosed herein relates to the art of turbomachines and, more particularly, to a combustor assembly for a turbomachine.

As requirements for gas turbine emissions have become more stringent, one approach to meeting such requirements is to move from conventional diffusion flame combustors to combustors utilizing lean fuel/air mixtures during fully premixed operation to reduce emissions of, for example, NOₓ and CO. These combustors are known in the art as Dry Low NOₓ (DLN), Dry Low Emissions (DLE) or Lean Pre Mixed (LPM) combustion systems. Such combustors typically include multiple fuel nozzles housed in a barrel, also known as a cap cavity.

Because these combustors operate at such lean fuel/air ratios, small changes in velocity can result in large changes in mass flow that may lead to fuel/air fluctuations. These fluctuations may result in a large variation in the rate of heat release as well as create high pressure fluctuations in a combustion zone portion of the combustor. Interaction of fuel/air fluctuation, vortex-flame interaction, and unsteady heat release may lead to a feed-back loop mechanism causing dynamic pressure pulsations in the combustion system. The phenomenon of pressure pulsations is referred to as thermo-acoustic or combustion-dynamic instability, or simply, combustion dynamics. High levels of combustion dynamics limit the operational envelope of the combustor by imposing limitations on emission reduction and power output. Repairing combustor components requires that the turbomachine be taken offline. Thus, in addition to costs associated with repairing the combustor components, additional costs are realized through lost turbomachine operation time.

### BRIEF DESCRIPTION OF THE INVENTION

According to one aspect of the exemplary embodiment, a turbomachine combustor includes a combustor cap having a cap surface and a wall that define, at least in part, a resonator volume. A plurality of injection nozzle members extend from the cap surface. The plurality of injection nozzle members include an inner nozzle member and a plurality of outer nozzle members. A conduit extends through the wall into the resonator volume. The conduit includes an internal passage having a dimensional parameter. A combustor dynamics mitigation system is operably connected to the combustor cap. The combustor dynamics mitigation system includes a controller configured and disposed to control one a size of the resonator volume and the dimensional parameter of the conduit to modify combustor dynamics in the combustor.

According to another aspect of the exemplary embodiment, a method of adjusting combustion dynamics in a combustor in a turbomachine includes passing a fluid through a conduit having a dimensional parameter into a resonator volume defined, at least in part, by a wall, and controlling one of a size of the resonator volume and the dimensional parameter of the conduit to adjust combustor dynamics in the combustor.

According to yet another aspect of the exemplary embodiment, a turbomachine includes a compressor portion, a turbine portion mechanically linked to the compressor portion, and a combustor assembly fluidly connected to the compressor portion and the turbine portion. The combustor assembly includes a combustor cap having a cap surface and a wall that extends about the cap surface to define, at least in part, a resonator volume. A plurality of injection nozzle members extend from the cap surface. The plurality of injection nozzle members include an inner nozzle member and a plurality of outer nozzle members. A conduit extends through the wall into the resonator volume. The conduit includes an internal passage having a dimensional parameter. A combustor dynamics mitigation system is operably connected to the combustor cap. The combustor dynamics mitigation system includes a controller configured and disposed to control one a size of the resonator volume and the dimensional parameter of the conduit to alter combustor dynamics in the combustor assembly.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a gas turbomachine system including a combustor assembly having a combustion dynamics mitigation system in accordance with an exemplary embodiment;

FIG. 2 is a perspective view of a combustor cap of the combustor assembly of FIG. 1 illustrating a volume adjusting plate, and a plurality of selectively shiftable divider members in accordance with an aspect of the exemplary embodiment;

FIG. 3 is a cross-sectional view of the combustor cap of FIG. 2 illustrating the volume adjusting plat and an adjustable conduit in accordance with an aspect of the exemplary embodiment;

FIG. 4 is a cross-sectional view of an adjustable conduit of the combustor cap of FIG. 3 shown in a first adjustment configuration;

FIG. 5 is a cross-sectional view of an adjustable conduit of the combustor cap of FIG. 4 shown in a second adjustment configuration;

FIG. 6 is an end view of an adjustable conduit of FIG. 3 in accordance with another aspect of the exemplary embodiment shown with a first outlet size;

FIG. 7 is an end view of the adjustable conduit of FIG. 6 shown with a second outlet size;

FIG. 8 is an end view of the adjustable conduit of FIG. 6 shown with a third outlet size;

FIG. 9 is an end view of the adjustable conduit of FIG. 6 shown with a fourth outlet size; and

FIG. 10 is a schematic diagram of the combustor dynamics mitigation system illustrating a controller coupled to the volume adjusting plate, the plurality of divider members, and the adjustable conduit.

The detailed description explains embodiments of the invention, together with advantages and features, by way of example with reference to the drawings.

### DETAILED DESCRIPTION OF THE INVENTION

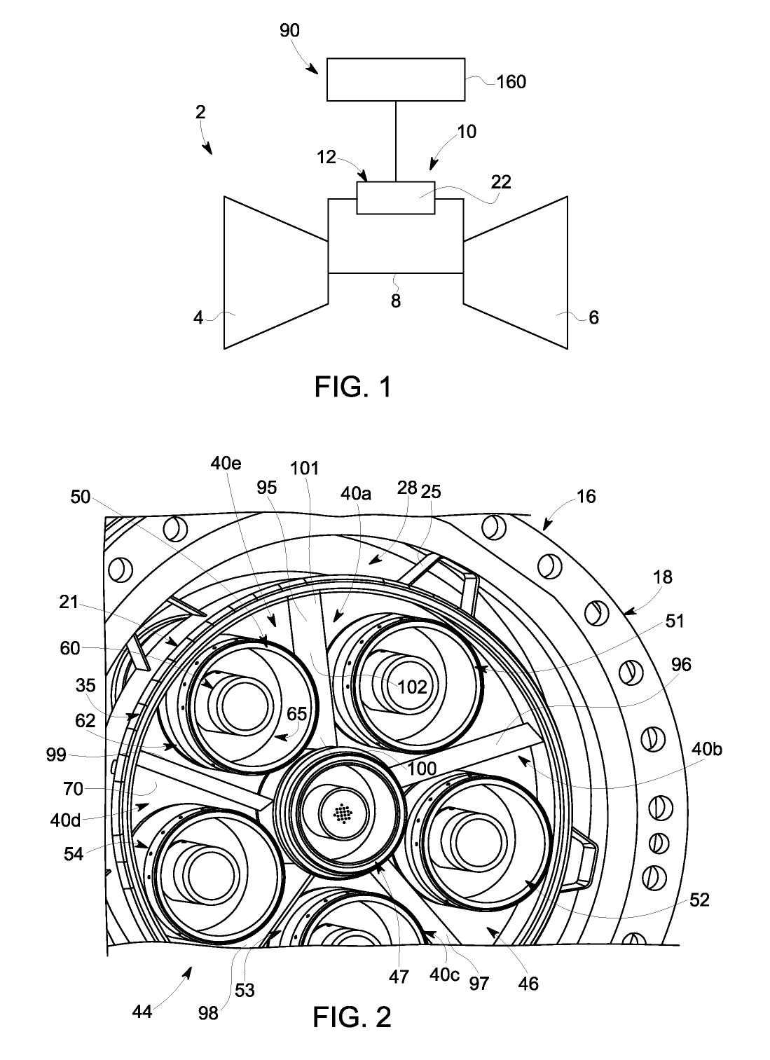

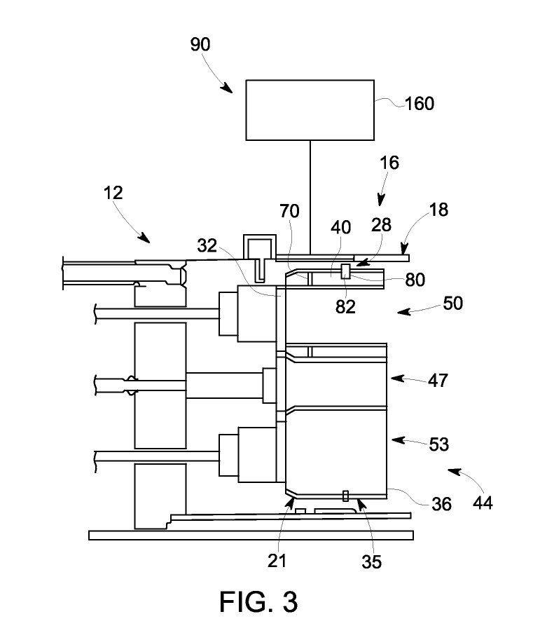

With reference to FIGS. 1-3 a gas turbomachine in accordance with an exemplary embodiment is indicated generally at 2. Gas turbomachine 2 includes a compressor portion 4 operatively connected to a turbine portion 6 through a common compressor/turbine shaft 8. Compressor portion 4 is also fluidly connected to turbine portion 6 via a combustor assembly 10 having a plurality of can-annular combustors, one of which is indicated at 12. In the exemplary embodiment shown, combustor assembly 12 includes a combustor cap 16 having a main body 18 that supports an injection nozzle assembly 21 and a combustion chamber 22. Injection nozzle assembly 21 is spaced from main body 18 by a plurality of support members, one of which is indicted at 25, so as to define a fluid flow path 28.

Injection nozzle assembly 21 includes a back plate or cap surface 32 that is surrounded by a wall 35 and an effusion plate 36. Cap surface 32 defines an upstream extent of combustor cap 16 and effusion plate 36 defines a downstream extent of combustor cap 16. Cap surface 32, wall 35 and effusion plate 36 collectively define a cap or resonator volume 40. Injection nozzle assembly 21 also includes a plurality of nozzle members 44 that extend from cap surface 32. The plurality of nozzle members 44 include a center nozzle 47 and a plurality of outer nozzles 50-54 that area arrayed about center nozzle 47. As each nozzle 47, and 50-54 are similarly constructed, a detailed description will follow describing outer nozzle 50 with an understanding that center nozzle 47, and outer nozzles 51-54 includes similar structure. Outer nozzle 50 includes an inner nozzle member 60 surrounded by an outer nozzle member 62. A swozzle volume 65 is defined therebetween. In accordance with one aspect of the exemplary embodiment, center nozzle 47 and outer nozzles 51-54 project through a volume adjusting plate 70. As will be discussed more fully below, volume adjusting plate 70 is selectively axially shiftable relative to cap surface 32 in order to adjust a size of resonator volume 40.

Injection nozzle assembly 21 is also shown to include one or more adjustable conduits 80 that extend through wall 35. Adjustable conduits 80 include an internal passage 82 having dimensional parameters such as length and an internal diameter. A fluid flow passing along fluid flow path 28 enters conduit 80 and flows into resonator volume 40. Resonator volume 40 produces pressure oscillations at a characteristic frequency that cancels out a natural frequency produced by pressure oscillations in combustion chamber 22 during operation of turbomachine 2. In order to adjust the frequency produced by resonator volume 40 and cancel out the pressure oscillations produced in combustion chamber 22, turbomachine 2 includes a combustion dynamics mitigation system 90 coupled to volume adjusting plate 70 and/or adjustable conduits 80.

In accordance with another aspect of the exemplary embodiment, injection nozzle assembly 21 also includes a plurality of divider members 95-99 that separate resonator volume 40 into a plurality of parallel resonator volumes 40a-40e. More specifically, divider members 95-99 extend from center nozzle member 47 to wall 35 between adjacent ones of outer nozzle members 50-54 so as to define parallel resonator volumes 40a-40e. Each parallel resonator volume 40a-40e is fluidly coupled to fluid flow path 28 via a corresponding adjustable conduit 80. As each divider member 95-99 is substantially similar, a detailed description will follow with reference to divider member 95. Divider member 95 includes a first end portion 100 that extends to a second end portion 101 through a substantially planar surface 102. First end 100 is pivotally mounted to inner nozzle member 47 while second end portion 101 is shiftable relative to wall 35. Divider members 95-99 are coupled to combustion dynamics mitigation system 90. In this manner, divider members 95-99 may be selectively moved to adjust a size of resonator volumes 40a-40e as will be discussed more fully below.

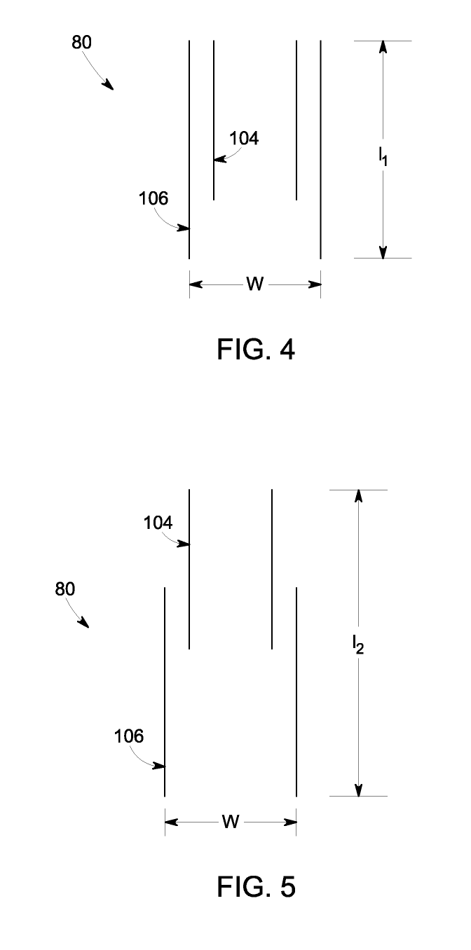

In accordance with another aspect of the exemplary embodiment illustrated in FIGS. 4-5, adjustable conduits 80 include a selectively adjustable length. More specifically, adjustable conduit 80 includes an inner conduit wall member 104 and an outer conduit wall member 106. Outer conduit wall member 106 is operably coupled to combustion dynamics mitigation system 90. As will be discussed more fully below, combustion dynamics mitigation system 90 may selectively shift inner conduit wall member 104 relative to outer wall member 106 to adjust a dimensional parameter, e.g., length of adjustable conduits 80. That is, outer conduit wall member 106 can be shifted to a first position, such as shown in FIG. 4 so as to establish a first length L₁ for adjustable conduit 80. Outer wall member 106 can be shifted to a second position such as shown in FIG. 5 so as to establish a second length L₂ of adjustable conduit 80. Outer wall 106 can also be arranged in any position in-between L₁ and L₂. In this manner, combustion dynamics mitigation system 90 allows for selective, individual adjustment of each adjustable conduit 80 to alter each resonator volume 40a-40e natural frequency to substantially cancel out the natural frequency of the dynamic pressure pulsations produced by combustor 12 and reduce undesirable noise output by turbomachine 2.

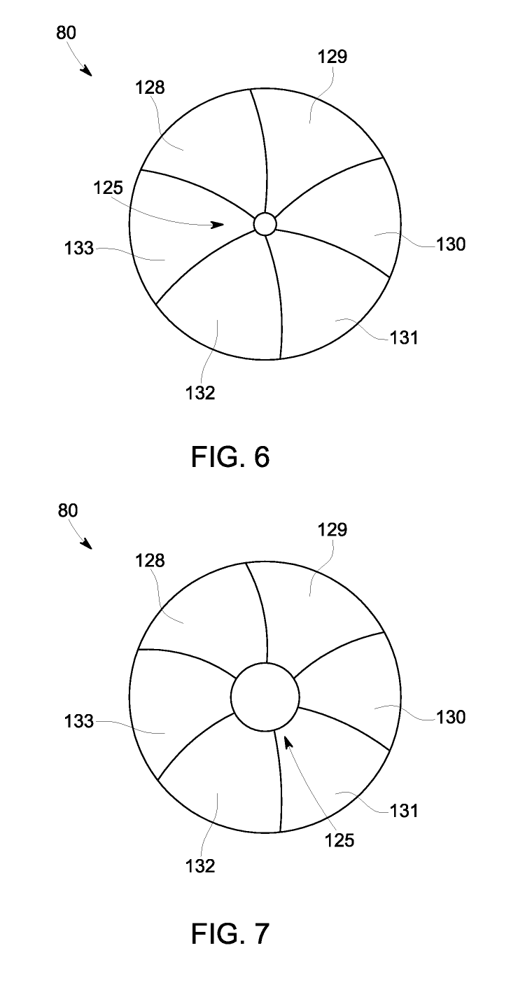

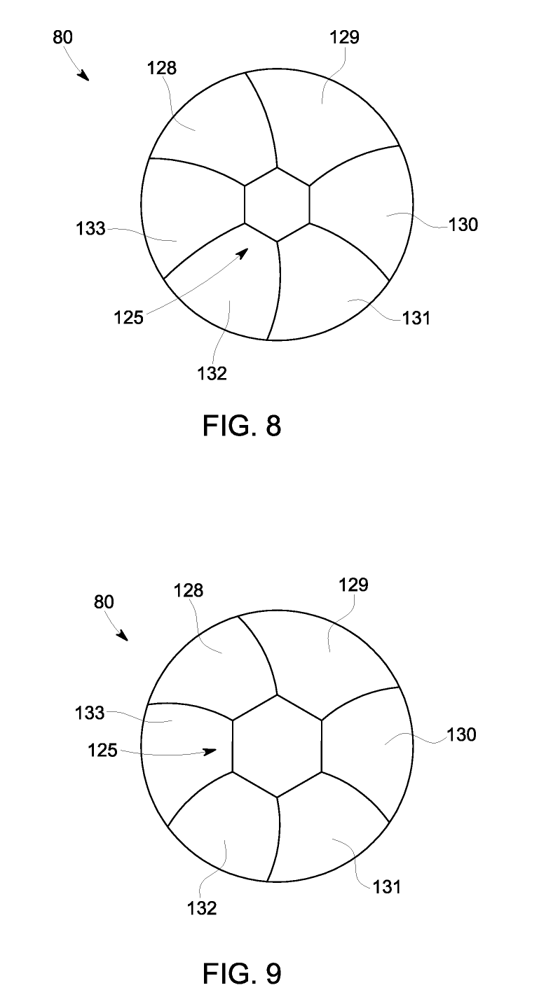

FIGS. 6-9 illustrate adjustable conduit 80 having a selectively adjustable diameter in accordance with another aspect of the exemplary embodiment. As shown, adjustable conduit 80 includes a selectively adjustable aperture 125 that is defined by a plurality of shiftable plates 128-133. Plates 128-133 are operably coupled to combustion dynamics mitigation system 90 and selectively moveable to adjust a dimensional parameter, e.g., outlet size, of internal passage 82 of conduit 80. Plates 128-133 may be shiftable, in a manner similar to that of a camera shutter, to control fluid flow from fluid flow path 28 into one or more of resonator volumes 40a-40e to substantially cancel out the natural frequency of the dynamic pressure pulsations produced by combustor 12 to reduce the undesirable noise output by the turbomachine.

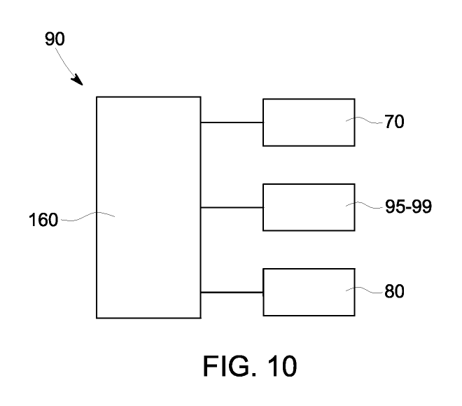

In accordance with an exemplary embodiment illustrated in FIG. 10, combustion dynamics mitigation system 90 includes a controller 160 that is configured to selectively control one or more of volume adjusting plate 70, divider members 95-99 and adjustable conduit 80. Controller 160 selectively adjusts volumetric parameters of resonator volume 40, resonator volumes 40a-40e, and/or a flow volume through adjustable conduit 80. More specifically, controller 94 may be activated to shift volume adjusting plate 70 relative to cap surface 32 to collectively change a size of resonator volume 40. Alternatively, controller 160 may control a position of one or more of divider members 95-99 to control a size of adjacent ones of resonator volumes 40a-40e. Controller 160 may also control fluid flow into one or more of resonator volumes 40a-40e by either adjusting a length parameter or an outlet parameter of one or more of adjustable conduits 80.

In this manner, combustion dynamics mitigation system 90 allows an operator to set a desired relative position of volume adjusting plate 70, divider members 95-99 and/or a dimensional parameter of adjustable conduit 80 to selectively tune the frequency of the resonator to cancel out the natural frequency of combustion dynamics produced during operation of turbomachine 2. During operation of turbomachine 2, fluctuations in fuel and air flow, vortex-flame interactions, and unsteady heat release from inner nozzle member 47 and outer nozzle members 50-54 all lead to dynamic pressure pulsations or combustion dynamics in the combustion system. The dynamic pressure pulsations have a natural frequency that creates undesirable noise output from the turbomachine. Combustion dynamics mitigation system 90 allows for selective, individual and or collective adjustment of one or more parameters of injector nozzle assembly 21 in order to fine tune and substantially cancel out the natural frequency of the dynamic pressure pulsations produced during operation of turbomachine 2.

Adjustable resonator volume(s) and/or adjustable conduits 80 act as an acoustic damper. Acoustic pressure and velocity is altered resulting in an overall system acoustic change. A size of and flow into the resonator volume(s) 40 is collectively and/or individually adjusted so as to resonate at a frequency (f) which is determined by a cross-sectional area (S) of each conduit 80, a length (L) of each conduit 80, and a volume (V) of the resonator volume(s) 40. The frequency is given by equation:

f=(c/(2*π))*sqrt(S/(V*L))

where “c” is the speed of sound. A desired frequency can be achieved by changing a volume of the parallel resonator volume(s) 40 or flow through adjustable conduit 80. To mitigate a natural frequency of the combustor assembly 12, a matching frequency is chosen, and the characteristics of V, L, and S are set to attain the desired frequency. To achieve the desired V, S or L, combustion dynamics mitigation system 90 may selectively control one or more of a position of volume adjusting plate 70, an angle of one or more of divider members 95-99 and/or a dimensional parameter of one or more of adjustable conduit 80. During operation of combustor assembly 12, the chosen frequency effectively “tunes out” the natural frequency created by the dynamic pressure pulsations thereby preventing and/or substantially eliminating issues associated with the occurrence of combustion dynamics.

At this point it should be understood that the exemplary embodiments provide a system that allows for individual adjustment of nozzle parameters to control combustion dynamics in a turbomachine. Canceling natural frequencies produced by pressure fluctuations due to a heat release process is desirable and leads to an increase between maintenance cycles and a lowering of maintenance costs. It should also be understood that turbomachine 2 may include at least one moveable volume adjusting plate, pivoting divider member, and adjustable conduits. It should also be understood that the turbomachine 2 may not be provided with divider members, be they stationary or pivoting.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine combustor comprising:
a combustor cap including a cap surface and a wall that define, at least in part, a resonator volume;
a plurality of injection nozzle members extending from the cap surface, the plurality of injection nozzle members including an inner nozzle member and a plurality of outer nozzle members;
a conduit extending through the wall into the resonator volume, the conduit including an internal passage having a dimensional parameter; and
a combustor dynamics mitigation system operably connected to the combustor cap, the combustor dynamics mitigation system including a controller configured and disposed to control one a size of the resonator volume and the dimensional parameter of the conduit to modify combustor dynamics in the combustor.

2. The turbomachine combustor according to claim 1, wherein the combustor cap includes a volume adjusting plate spaced from the cap surface and extending about each of the plurality of injection nozzle members, the controller being configured and disposed to shift the volume adjusting plate relative to the cap surface to alter a size of the resonator volume.

3. The turbomachine combustor according to claim 2, wherein the volume adjusting plate is axially shiftable relative to the cap surface.

4. The turbomachine combustor according to claim 1, wherein the conduit includes a plurality of plates that define an adjustable aperture, the controller being configured to shift the plurality of plates to adjust a diameter of the internal passage.

5. The turbomachine combustor according to claim 1, wherein the conduit includes an inner conduit wall member and an outer conduit wall member, the controller being configured to selectively shift one of the outer conduit wall member and the inner conduit wall member relative to another of the outer conduit wall member and the inner conduit wall member to adjust a length of the conduit.

6. The turbomachine combustor according to claim 1, further comprising: a plurality of divider members extending from the inner nozzle member to the wall between adjacent ones of the plurality of outer nozzle members to separate the resonator volume into a plurality of resonator volumes, the plurality of divider members being operatively coupled to the controller and selectively shiftable along the wall to adjust a size of the plurality of resonator volumes.

7. The turbomachine combustor according to claim 1, wherein the controller is configured to reduce combustion dynamics in the combustor.

8. A method of adjusting combustion dynamics in a combustor in a turbomachine, the method comprising:
passing a fluid through a conduit having a dimensional parameter into a resonator volume defined, at least in part, by a wall; and
controlling one of a size of the resonator volume and the dimensional parameter of the conduit to adjust combustor dynamics in the combustor.

9. The method of claim 8, wherein controlling the size of the resonator volume includes shifting a volume adjustable plate relative to a cap surface.

10. The method of claim 8, wherein controlling the size of the resonator volume includes shifting one or more divider members that extend from an inner nozzle member to the wall between adjacent ones of a plurality of resonator volumes to adjust a size of one or more of a plurality of resonator volumes.

11. The method of claim 8, wherein controlling the dimensional parameter of the conduit includes selectively adjusting a size of an outlet of the conduit.

12. The method of claim 8, wherein controlling the dimensional parameter of the adjustable conduit includes selectively adjusting a length of the conduit.

13. The method of claim 8, wherein controlling the one of the size of the resonator volume and the dimensional parameter of the conduit produces a sound having a frequency that cancels out a natural frequency produced by one or more injector members during operation of the turbomachine.

14. A turbomachine comprising:
a compressor portion;
a turbine portion mechanically linked to the compressor portion; and
a combustor assembly fluidly connected to the compressor portion and the turbine portion, the combustor assembly including:
a combustor cap including a cap surface and a wall that extends about the cap surface to define, at least in part, a resonator volume;
a plurality of injection nozzle members extending from the cap surface, the plurality of injection nozzle members including an inner nozzle member and a plurality of outer nozzle members;
a conduit extending through the wall into the resonator volume, the conduit including an internal passage having a dimensional parameter; and
a combustor dynamics mitigation system operably connected to the combustor cap, the combustor dynamics mitigation system including a controller configured and disposed to control one a size of the resonator volume and the dimensional parameter of the conduit to alter combustor dynamics in the combustor assembly.

15. The turbomachine according to claim 14, wherein the combustor cap includes a volume adjusting plate spaced from the cap surface and extending about each of the plurality of injection nozzle members, the controller being configured and disposed to shift the volume adjusting plate relative to the cap surface to alter a size of the resonator volume.

16. The turbomachine according to claim 15, wherein the volume adjusting plate is axially shiftable relative to the combustor cap.

17. The turbomachine according to claim 14, wherein the conduit includes a plurality of plates that define a selectively adjustable aperture, the controller being configured to shift the plurality of plates to adjust a diameter of the internal passage.

18. The turbomachine combustor according to claim 14, wherein the conduit includes an inner conduit wall member and an outer conduit wall member, the controller being configured to shift one of the outer conduit wall member and the inner conduit wall member relative to the other of the outer conduit wall member and the inner conduit wall member to adjust a length of the conduit.

19. The turbomachine combustor according to claim 14, further comprising: a plurality of divider members extending from the inner nozzle member to the wall between adjacent ones of the plurality of outer nozzle members to separate the resonator volume into a plurality of resonator volumes, the plurality of divider members being operatively coupled to the controller and shiftable along the wall to adjust a size of the plurality of resonator volumes.

20. The turbomachine according to claim 14, wherein the controller is configured to reduce combustion dynamics in the combustor assembly.
